(19) United States
(12) Patent Application Publication
(10) Pub. No.: US 2004/0267609 A1
(43) Pub. Date: Dec. 30, 2004

(54) Methods and systems for specifying and distributing consumer information

(76) Inventor: David R. McCauley, Boise, ID (US)

Correspondence Address: HOYT A. FLEMING III, P.O. BOX 140678, BOISE, ID, 83714, US

(21) Appl. No.: 10/602,431

(22) Filed: Jun. 24, 2003

(51) Int. Cl. G06F 17/60

(52) U.S. Cl. 705/14

(57) ABSTRACT

A method that is implemented by one or more computers. The method compensates a consumer for providing information to a first company, such as a consumer information management company. The method includes receiving a request to create a license. The license grants the first company the right to sublicense the information and obligates the first company to provide the consumer with a percentage of the monies that the first company receives for sublicensing the information. The method also includes receiving the information; sublicensing the information to a second company; and providing the consumer with the percentage of the monies received for sublicensing the information to the second company.

### 1. FIELD OF THE INVENTION

The present invention generally relates to methods and systems for licensing consumer information from consumers and sublicensing the consumer information to businesses.

### 2. BACKGROUND

Costs associated with data entry, computer processing, data storage and communications have rapidly decreased since the early 1990's. Such declines in cost have allowed businesses to store and analyze transactions with both current and potential consumers. Initially, this data gathering was used to identify sales opportunities for products within a company. In particular, large corporations shared data between divisions. By reviewing the consumer information contained in the transactions and matching the corresponding consumer with other products, businesses could identify which consumers would most likely make another purchase. For example, an insurance company could gather consumer information using an individual's application for automobile insurance. This information, which includes personal data such as home ownership, insurance claims history and a credit score, could be stored in a consumer database. Using selection criteria against the personal data gathered in the consumer database, the company could directly market that consumer with another product, such as homeowner insurance.

Eventually, as consumer databases increased in size and depth of information, businesses realized the financial value of the collected consumer information not only to their business, but to other businesses as well. For some companies, consumer information became a commodity. There are numerous companies that gather, analyze, develop and sell consumer profiles based on the consumer information collected from different sources. Two such examples are Equifax Corporation and Experian Corporation, both of which supply businesses with credit reports, credit scoring, or other types of consumer information.

Similarly, companies, such as PaloAlto Research, a subsidiary of QuarterEnd, Incorporated, collect personal information from consumers through the implementation of surveys. The results of the surveys are then analyzed and sold to direct marketers. Participants who provide the personal information are often compensated with gift certificates, free products, or other means.

The value of consumer information decreases rapidly if the consumer information is not current. Unfortunately, maintaining current consumer information is difficult, time consuming and expensive. Thus, a need exists for a method and a system that efficiently obtains consumer information and provides timely updates to such information.

### 3. SUMMARY OF THE INVENTION

One embodiment of the invention is a method that is implemented by one or more computers. The method compensates a consumer for providing information to a first company, such as a consumer information management company. The method includes receiving a request to create a license. The license grants the first company the right to sublicense the information and obligates the first company to provide the consumer with a percentage of the monies that the first company receives for sublicensing the information. The method also includes receiving the information; sublicensing the information to a second company; and providing the consumer with a percentage of the monies received for sublicensing the information to the second company.

Another embodiment of the invention is a method that is implemented by one or more computers. The method compensates a consumer for providing information to a first company, such as a consumer information management company. The method includes receiving a request to create a license. The license grants the first company the right to sublicense the information. The license also obligates the first company to provide the consumer with a first percentage of the monies that the first company receives for sublicensing the information if the consumer updates the information within a certain time period and a second percentage of the monies that the first company receives for sublicensing the information if the consumer does not update the information within the certain time period. The method also includes: receiving the information; sublicensing the information to a second company; and providing the consumer with either the first percentage or the second percentage of the monies received for sublicensing the information to the second company.

Yet another embodiment of the invention is a method that is implemented by one or more computers. The method compensates a consumer for providing information to a first company, such as a consumer information management company. The method includes receiving a request to create a license. The license grants the first company the right to sublicense the information. The license also obligates the first company to provide the consumer with a first amount if the consumer updates the information within a certain time period and a second amount if the consumer does not update the information within the certain time period. The method also includes receiving the information; sublicensing the information to a second company; and providing the consumer with either the first amount or the second amount.

### 4. BRIEF DESCRIPTION OF THE FIGURES

FIG. 1 presents a block diagram illustrating the primary components of a system that operates in accordance with some embodiments of the present invention.

FIG. 2 presents a method of collecting consumer information.

FIG. 3 presents an Enter Personal Profile Web document.

FIG. 4 presents a Select Industry Types for Marketing Surveys Web document.

FIG. 5 presents a method for creating licenses for consumers who provide consumer information.

FIG. 6 presents a Create License Web document.

FIG. 7 presents a Select Industry Types Web document.

FIG. 8 presents a method of calculating a payment to consumers.

### 5. DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

5.1 Glossary of Terms and Acronyms

The following terms and acronyms are used throughout the detailed description:

Cookies. A technology that enables a Web server to retrieve information from a consumer's computer that reveals prior browsing activities of the consumer. The informational item stored on the consumer's computer (typically on the hard drive) is commonly referred to as a “cookie.” Many standard Web browsers support the use of cookies.

Hyperlink. A navigational link from one document to another, or from one portion (or component) of a document to another. Typically, a hyperlink is displayed as a highlighted word or phrase that can be selected by clicking on it using a mouse to jump to the associated document or portion.

HTML (HyperText Markup Language). A standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally, in specifying how the Web browser is to display the document, HTML tags can be used to create hyperlinks to other Web documents. For more information on HTML, see Ian S. Graham, The HTML Source Book, John Wiley and Sons, Inc., 1995 (ISBN 0471-11894-4).

Hypertext System. A computer-based informational system in which documents (and possibly other types of data entities) are linked together via hyperlinks to form a consumer navigable “web.”

HTTP (HyperText Transport Protocol). The standard World Wide Web client-server protocol used for the exchange of information (such as HTML documents and client requests for such documents) between a browser and a Web server. HTTP includes a number of different types of messages that can be sent from the client to the server to request different types of server actions. For example, a “GET” message, which has the format GET <URL>, causes the server to return the document or file located at the specified URL.

Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations that may be made in the future, including changes and additions to existing standard protocols.)

URL (Uniform Resource Locator). A unique address which fully specifies the location of a file or other resource on the Internet. The general format of a URL is “protocol://machine address:port/path/filename.” The port specification is optional, and if the consumer specifies none, the browser defaults to the standard port for the protocol. For example, if HTTP is specified as the protocol, the browser will use the HTTP default port of 80.

Web Site. A computer system that serves informational content over a network using the standard protocols of the World Wide Web. Typically, a Web site corresponds to a particular Internet domain name, such as “cardsurfer.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services.

World Wide Web (“Web”). Used to refer generally to both (i) a distributed collection of interlinked, viewable hypertext documents (commonly referred to as Web documents or Web pages) that are accessible via the Internet, and (ii) the client and server software components that provide consumer access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols that may be used in place of (or in addition to) HTML and HTTP.

5.2 System Components

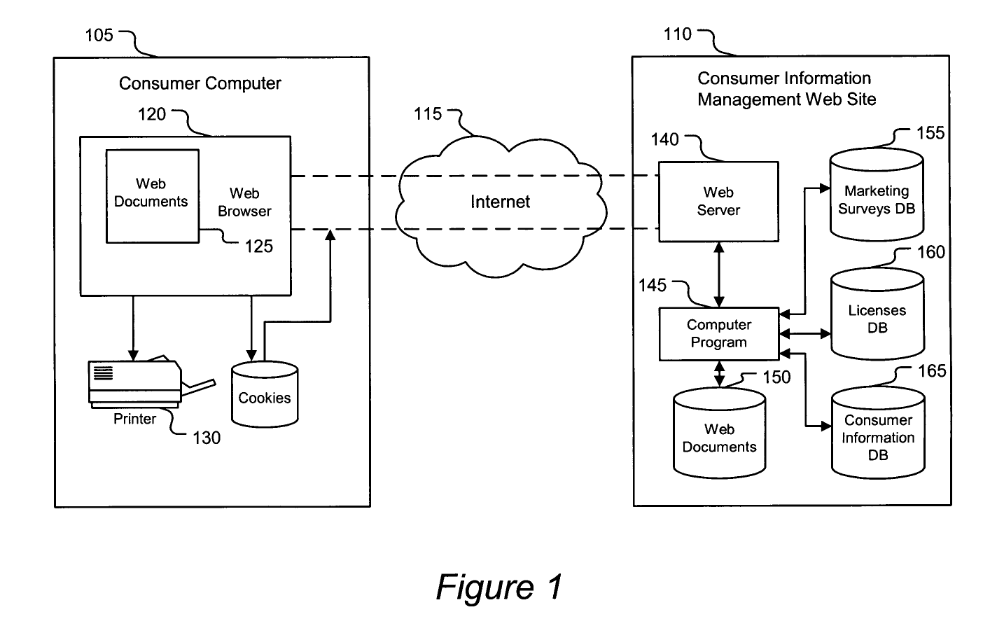

FIG. 1 illustrates a simplified block diagram of a consumer computer 105 and a consumer information management Web site 110, both of which are linked together by the Internet 115. Those skilled in the art will appreciate that the block diagram of FIG. 1 is simplified to illustrate only those functional elements of interest in describing the present invention.

5.2.1 Consumer Computer

The consumer computer 105 is conventional. The consumer computer 105 may be any type of computing device that allows a consumer to interactively browse Web sites on the World Wide Web via a Web browser. For example, the consumer computer 105 may be a personal computer (PC) that runs a Windows operating system, an Apple computer, a Web appliance, a hand held computer, or even a telephone. The consumer computer 105 typically includes a Web browser 120, such as Microsoft's Internet Explorer, which uses the HTTP protocol to communicate with Web servers. As is well known, the Web browser 120 can request, receive, and display Web documents 125 as well as other data entities such as Adobe PDF documents. If printing of Web documents or other documents is desired, then the consumer computer 105 may also include a printer 130.

5.2.2 Consumer Information Management Web Site

The consumer information management Web site 110 is a web site that allows consumers to enter and receive data as will be discussed more fully below.

The consumer information management Web site 1110 includes a Web server 140 that typically sends a plurality of Web documents 150 such as HTML documents to the consumer computer 105. In addition, the Web server 140 uses the HTTP protocol to receive requests and information from the consumer computer 105. A computer program 145 implements the content, flow and functionality of the Web documents 150. This computer program 145 may store consumer information received from the consumer computer 105 in a database such as the consumer information database 165 shown in FIG. 1. Likewise, as will be more fully discussed below, the computer program 145 may store licenses in a database such as the licenses database 160 shown in FIG. 1. The computer program 145 may also store the contents of consumer surveys in a database such as the marketing surveys database 155 shown in FIG. 1. Some embodiments of the computer program 145 utilize a single database to store all of the above information, while other embodiments of the computer program 145 utilize two or more databases to store such information.

5.3 Collect Consumer Information

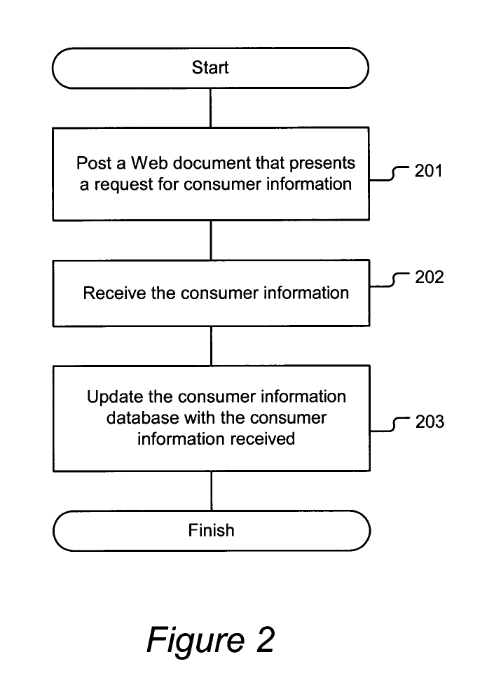

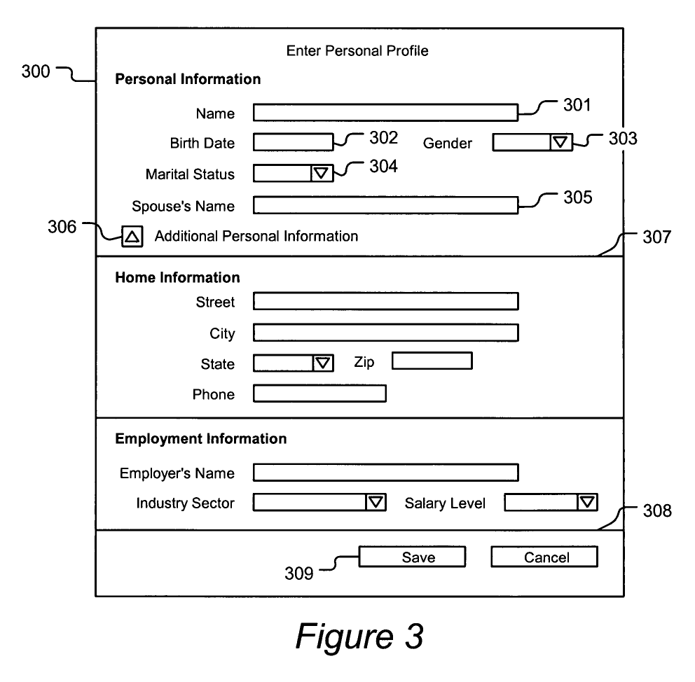

In one embodiment of the invention, the consumer information management Web site 110 collects consumer information. Referring to block 201 of FIG. 2, the consumer information management Web site 110 can post a Web document that presents a request for consumer information. For example, an “Enter Personal Profile” Web document 300, such as shown in FIG. 3, could be posted. The Enter Personal Profile Web document 300 could allow the consumer to specify information that typically remains static. For example, the Enter Personal Profile Web document 300 may contain a field 301 for entering the consumer's name, a field 302 for entering the consumer's birth date, a field 303 for specifying the consumer's gender, a field 304 for specifying the consumer's marital status and a field 305 for entering the name of the consumer's spouse. The Enter Personal Profile Web document 300 may include an Additional Personal Information icon 306. If the consumer selects the Additional Personal Information icon 306, then the Enter Personal Profile Web document 300 could allow the consumer to enter dynamic personal information such as home address; home phone number; business address; business phone number; email address; number of children; income level; employer name; and employment industry sector. In addition, the requested information may include areas of interest provided by the consumer such as hobbies, sports, and travel destinations. Based upon the provided areas of interest, the requested information may ask for detailed information related to the areas of interest. For example, if a consumer indicates an interest in travel, the personal information could include the consumer's preferred hotel chain, preferred airline and preferred vehicle rental company.

In some embodiments of the invention, if the consumer selects the Additional Personal Information icon 306, the Enter Personal Profile Web document 300 could either hide or display the information located between lines 307 and line 308. In other embodiments of the invention, if the consumer selects the Additional Personal Information icon 306, then the consumer information management Web site 110 could post a separate Web document or a plurality of Web documents to allow the consumer to provide additional information.

In some embodiments of the invention, when the consumer selects the Save button 309 as shown in FIG. 3, the consumer computer 105 transmits the previously entered consumer information to the consumer information management Web site 110. As shown in block 202 of FIG. 2, the consumer information management Web site 110 then receives the consumer information data. Next, as shown in block 203 of FIG. 2, the consumer information management Web site 110 stores the received data in a database, such as a consumer information database 165.

In some embodiments of the invention, the consumer information is collected by providing a plurality of password protected Web documents that can be accessed by consumers. These Web documents could provide functionality for allowing consumers to easily and timely provide the above consumer information. Such Web documents may also include functionality for allowing the consumer to certify that the provided information is accurate as of a specified date. Some embodiments of the invention utilize cookies to verify the identity of the consumer.

In other embodiments of the invention, a database, such as the consumer information database 165 shown in FIG. 1, could be populated with personal data collected through the implementation of consumer surveys. The consumer surveys may consist of a series of questions that a company could use to determine the market for a new product or to collect consumer opinions on existing products. For example, a satellite company may wish to survey 10,000 consumers in the Seattle area, between a certain age, gender and income level and query the consumers if they are interested in purchasing satellite TV service. In some embodiments of the invention, the consumer information management Web site 110 may post one or more Web documents to allow the consumer to participate in the consumer survey and provide the personal information. In other embodiments of the invention, a hyperlink may be provided in an email sent to the consumer that would provide access to the consumer survey.

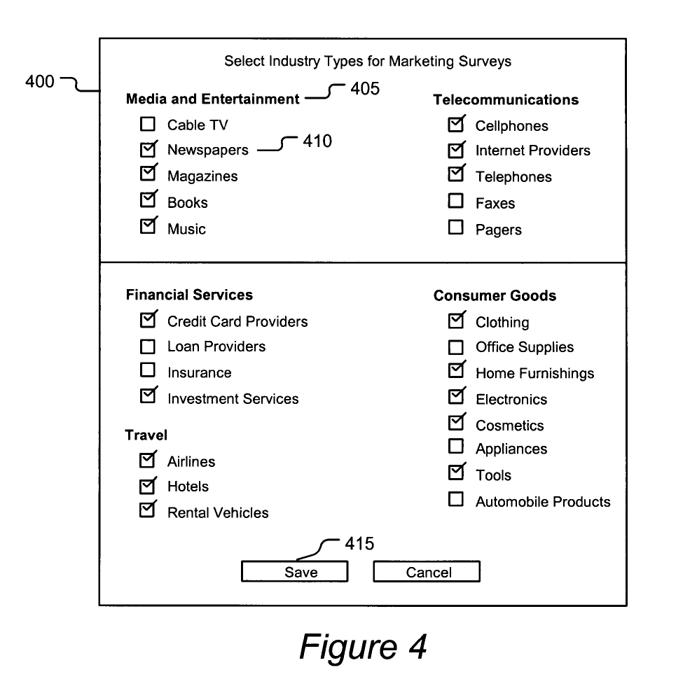

In still other embodiments of the invention, the consumer information management Web site 110 could post a Web document or a plurality of Web documents to allow the consumer to specify types of industry sectors that the consumer is interested in participating in marketing surveys as discussed above. Types of industry sectors could include some or all of the following: Media and Entertainment; Telecommunications; Financial Services; Consumer Goods; Travel; Public Interest Groups; Consumer Services; and Hobbies. As shown in FIG. 4, the consumer information management Web site 10 could display a “Select Industry Types for Marketing Surveys” Web document 400 that allows a consumer to indicate an interest in participating in a marketing survey by clicking on a checkbox.

In other embodiments of the invention, a database, such as the consumer information database 165 shown in FIG. 1, may be populated by requesting consumers to provide information via fax, U.S. mail, or electronically, such as by email. The received data could then be electronically or manually loaded into a database.

5.4 Create Licenses for Consumers Who Provide Consumer Information

The consumer information management Web site 110 may also allow the creation of license agreements between consumers and a consumer information management company.

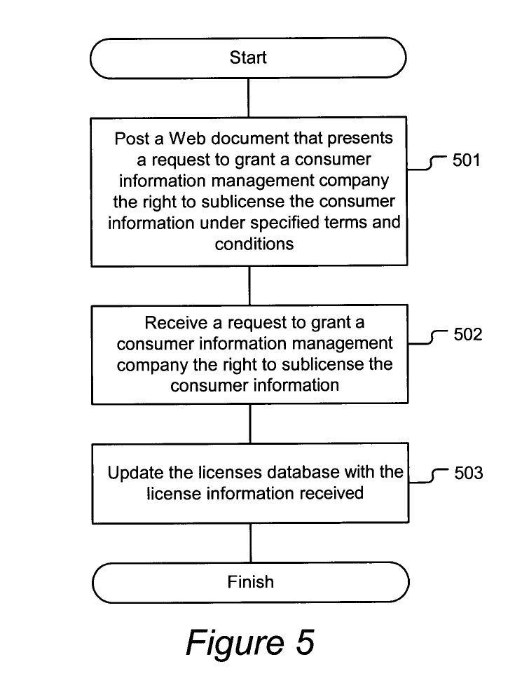

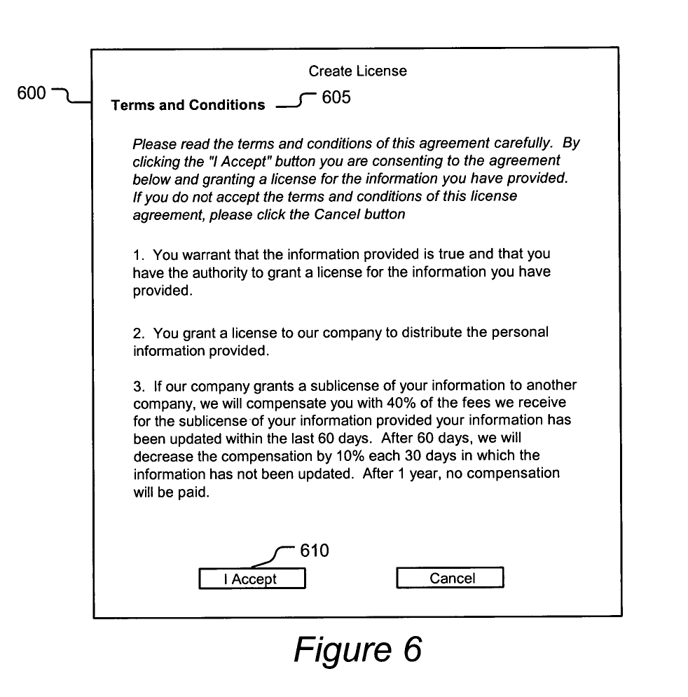

Referring to block 501 of FIG. 5, in some embodiments of the invention, the consumer information management Web site 110 could post a Web document that presents a request to grant the consumer information management company the right to sublicense the consumer information under specified terms and conditions. For example, a “Create License” Web document 600, such as shown in FIG. 6, could be posted. The Create License Web document 600 contains a Terms and Conditions field 605 that lists the terms and conditions for a consumer to grant the right to sublicense the consumer's information. For example, the terms and conditions may require that the consumer warrant that the provided consumer information is accurate and that the consumer has the authority to grant a sublicense for the consumer's information.

As shown in FIG. 6, in some embodiments of the invention, the terms and conditions of the license agreement require the consumer information management company to compensate the consumer if the consumer's information is sublicensed. For example, if the consumer information management company sublicenses the consumer's information, then the consumer will receive a predetermined percentage of the sublicense fee received for sublicensing the consumer's information. For example, the consumer may receive 40% of the sublicense fee received by the consumer information management company for the consumer's information.

In other embodiments of the invention, the consumer may receive a predetermined percentage of the sublicense fee only if the consumer's information has been recently updated. Otherwise, the consumer will not receive any compensation for the consumer's information.

In still other embodiments of the invention, such as shown in FIG. 6, the consumer may receive a predetermined percentage of the sublicense fee if the consumer's information has been recently updated and a lesser percentage of the sublicense fee if the consumer's information has not been recently updated. For example, the consumer may receive 40% of the sublicense fee received for sublicensing the consumer's information if the consumer has updated his/her information within the last 60 days. However, the compensation could be reduced by an amount, such as 10%, for each 30 day period (after 60 days) that the consumer does not update his/her information. Thus, after a relatively long period, the consumer information management company may sublicense the consumer's information without compensating the consumer.

When the consumer selects the “I Accept” button 610 as shown in FIG. 6, the consumer computer 105 transmits a request (to the consumer information management Web site 110) to create a license according to certain terms and conditions. Referring to block 502 of FIG. 5, the consumer information management Web site 110 receives the request. Then, referring to block 503 of FIG. 5, the consumer information management Web site 110 would store the license information in a database, such as the licenses database 160 shown in FIG. 1.

This license agreement could be created before the consumer enters the consumer's information. For example, as will be discussed below, the consumer could select various license terms and conditions from one or more Web documents. Then the consumer could create a license with a consumer information management company before the user enters any information about the consumer. Alternatively, the terms and conditions of the license agreement could be created while the consumer enters the consumer's information. In such embodiments, the information entered by the consumer could be utilized to create additional terms and conditions in the license agreement. For example, if the consumer indicates that he/she is interested in travel, then a term and condition in the license agreement could be presented to the consumer related to sublicensing the consumer's information to travel agencies without the consumer's consent. The consumer would be free to accept or deny such terms and conditions. Thereafter, the consumer could continue entering additional consumer information and accepting or rejecting additional terms and conditions of the license agreement that are related to the entered information. Alternatively, the license could be created after the consumer enters the consumer's information.

In other embodiments of the invention, the licenses database 160 may be populated by requesting consumers to provide the above license information via fax, U.S. mail, or electronically, such as by email. The received data could then be electronically or manually loaded into the licenses database 160.

5.5 Sublicense Consumer Information

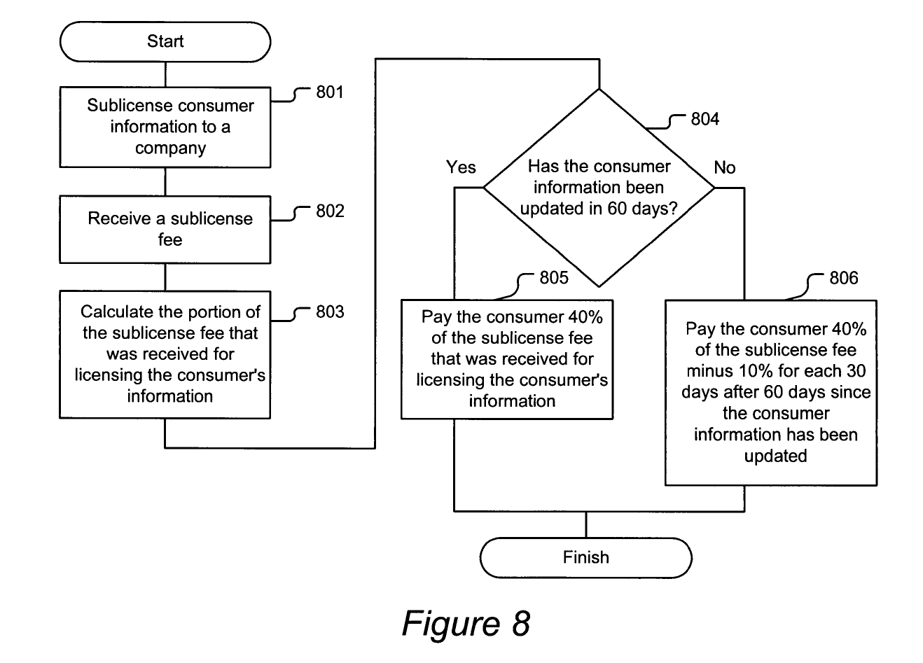

After a license agreement has been entered into and the consumer has provided his/her consumer information to the consumer information management company, then, as shown in block 801 of FIG. 8, the consumer information management company may sublicense the consumer information to other companies. In exchange for sublicensing the consumer information, as shown in block 802 of FIG. 8, the consumer information management company receives a fee.

5.6 Calculate the Amount Received for Sublicensing the Consumer's Information

After the consumer information management company has received the sublicense fee, then, as shown in block 803 of FIG. 8, the consumer information management Web site 110 can calculate the portion of the sublicense fee that was received for licensing a particular consumer's information. For example, if the consumer information management company received X dollars for licensing the information of 10,000 consumers, then the portion of the sublicense fee received for a particular consumer's information could be equal to $X/10,000. However, if a particular consumer's information was incomplete, did not meet a certain criteria, or was not recently updated, then the amount received for sublicensing the consumer's information could be less than $X/10,000. Alternatively, if the particular consumer's information was complete, did meet certain criteria, and/or was recently updated, then the amount received for sublicensing the consumer's information could be greater than $X/10,000.

5.7 Calculate the Consumer's Compensation

Next, as shown in blocks 804 through 806 of FIG. 8, the consumer information management Website 110 could calculate the compensation that a consumer will receive for licensing the consumer's information.

For example, if the terms and conditions of a license agreement with the consumer are as stated in FIG. 6, then the consumer information management Web site 110 could first determine whether the consumer information has been updated within the last 60 days. If the consumer information has been updated within 60 days, then, referring to block 805 of FIG. 8, the consumer information management Web site 110 could pay the consumer who provided the personal information 40 percent of the price of the sub-license fee that was received for licensing the consumer's information. Otherwise, referring to block 806 of FIG. 8, the consumer information management Web site 110 could pay the consumer who provided the personal information a lesser amount based upon the length of the period of time since the consumer has updated his/her information. Such payments could be made via electronic transfers to a credit card or via PayPal, etc. By compensating the consumer with a larger amount of money when the consumer's information has been recently updated, the consumer is motivated to timely update his/her information. Thus, the consumer information management company's difficulty and expense of maintaining current consumer information is reduced.

5.8 Other Embodiments of the Invention

In some embodiments of the invention, if a consumer does not update their personal information in a timely manner, an electronic notice such as an email may be automatically sent to the consumer requesting an update. The email may include a hyperlink, that when selected, directs the consumer to a Web document, such as shown in FIG. 3, that would provide a means to update the personal information.

In some embodiments of the invention, the consumer would be compensated with an amount of money, which may not be based upon the monies received by the consumer information management company, each time the consumer's information is sublicensed.

In other embodiments of the invention, the consumer would be compensated with a first amount of money, which may not be based upon the monies received by the consumer information management company, each time the consumer's information is sublicensed if and only if the consumer's information has been updated within a predetermined time period. If the consumer's information has not been updated within the time period, then the consumer may be compensated with a less amount of money or may not be compensated at all.

In still other embodiments of the invention, the terms and conditions of the license may require that the consumer information management company receive the consumer's consent before sublicensing the consumer's information to any third party. In such embodiments, the consumer may receive an email or fax requesting the consumer's consent before the consumer information management company sublicenses the consumer's information. The email may also include the amount of money that the third party is willing to pay for the consumer's information. The email may also include the amount of money that the consumer will receive for allowing the consumer information management company to sublicense the consumer's information to the third party. Thus, the consumer can make an informed decision as to whether to sublicense the consumer's information to the third party.

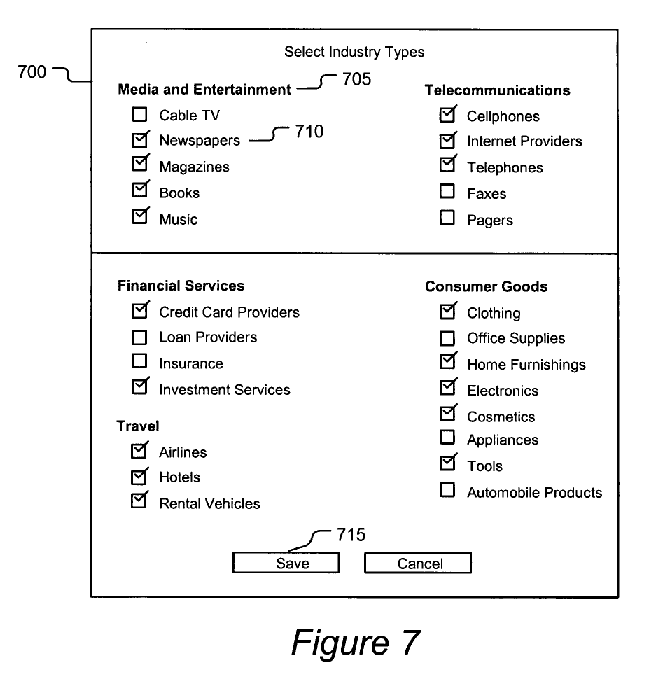

In still other embodiments of the invention, the terms and conditions of the license may identify one or more groups of companies to which the consumer information management company may sublicense the consumer's information without obtaining the consumer's consent. For example, the terms and conditions of the license may allow the consumer information management company to sublicense a consumer's information to companies within industry segments that the consumer selects via checkboxes on a Web document. In such embodiments of the invention, the consumer information management Web site 110 could post a Web document or a plurality of Web documents that allow the consumer to specify types of industries to which the consumer information management company could sublicense the consumer's information. Such industry types could include some or all of the following: Media and Entertainment; Telecommunications; Financial Services; Consumer Goods; Travel; Public Interest Groups; Consumer Services; and Hobbies. As shown in FIG. 7, the consumer information management Web site 110 could display a “Select Industry Types” Web document 700 to allow the consumer to select such industry types. If a consumer selects one or more industry segments, then the terms and conditions of the license would be modified accordingly.

5.9 Conclusion

Some embodiments of the invention provide a consumer with a predetermined percentage of the monies received by a consumer information management company when the company sublicenses the consumer's information. Thus, in such embodiments, the consumer obtains a financial benefit each time the consumer information management company sublicenses the consumer's information. It is believed that consumers will be more likely to provide consumer information when they receive a predetermined percentage of the fee received by the consumer information management company for sublicensing the consumer's information. Thus, the time and expense of a consumer information management company to obtain consumer information can be reduced.

Some embodiments of the invention provide consumers with extra compensation if the consumer timely updates his/her consumer data. Thus, such embodiments motivate a consumer to timely update his/her consumer information. This motivation can reduce the time and expense of a consumer information management company to maintain current information.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention.

The above descriptions of embodiments of the present invention include words such as “first,” “then,” and “next.” These words indicate a sequence of acts. Many of the sequences can be modified within the scope of the invention. Thus, unless the result of a first act is required for a second act, then the language indicating a sequence should not be considered to be a limitation to the invention. Similarly, the phrase “for example,” is intended to be illustrative and not limiting.

Many of the numerous embodiments described above can be combined to form a very powerful consumer information management Web site. Such combinations are intended to be within the scope of the invention.

While the invention has been described above with reference to certain preferred embodiments of the invention, these embodiments have been presented by way of example only, and not to limit the scope of the invention. Accordingly the scope of the present invention is defined by the appended claims.

It is claimed:

1. A method implemented by one or more computers of compensating a consumer for providing information to a first company, the method comprising:
receiving a request to create a license, the license granting the first company the right to sublicense the information, the license obligating the first company to provide the consumer with a percentage of the monies that the first company receives for sublicensing the information;
receiving the information;
sublicensing the information to a second company; and
providing the consumer with the percentage of the monies received for sublicensing the information to the second company.

2. The method of claim 1, wherein receiving the request to create a license includes receiving a request to create a license that obligates the first company to provide the consumer with 40% of the monies that the first company receives for sublicensing the information.

3. The method of claim 1, wherein receiving the request to create a license includes receiving a request to create a license that obligates the first company to provide the consumer with a first percentage of the monies that the first company receives for sublicensing the information if the consumer updates the information and a second percentage of the monies that the first company receives for sublicensing the information if the consumer does not update the information.

4. The method of claim 1, wherein receiving the request to create a license includes receiving a request to create a license that obligates the first company to provide the consumer with a first percentage of the monies that the first company receives for sublicensing the information if the consumer updates the information within a first period of time, and a second percentage of the monies that the first company receives for sublicensing the information if the consumer updates the information within a second period of time, which is greater than the first period of time.

5. The method of claim 1, wherein receiving the request to create a license includes receiving a request to create a license that obligates the first company to obtain the consent of the consumer to sublicense the information to a second company.

6. The method of claim 1, wherein receiving the request to create a license includes receiving a request to create a license that obligates the first company to obtain the consent of the consumer to sublicense the information to a second company if the second company is in a first industry sector but not if the second company is in a second industry sector.

7. The method of claim 1, wherein receiving the information includes receiving one or more of the following: marital status; spouse's name; home address; home phone number; business address; business phone number; email address; number of children; income level; employer name; and employment industry sector.

8. The method of claim 1, wherein receiving the information includes receiving the information from a consumer computer via the Internet.

9. The method of claim 1, wherein receiving the information includes receiving the information from a telephone.

10. The method of claim 1, wherein receiving the information includes receiving the information from a handheld computer.

11. The method of claim 1, wherein receiving the information includes receiving an area of interest provided by the consumer and then receiving information that is based upon the area of interest provided by the consumer.

12. The method of claim 1, wherein receiving the information includes sending an email to a computer that includes a hyperlink.

13. The method of claim 1, wherein the request to create a license is received before the information is received.

14. The method of claim 1, wherein at least one term in the license is based upon the information.

15. The method of claim 1, wherein at least one term in the license is based upon the information and wherein the request to create a license is received after the information is received.

16. The method of claim 1, wherein the request to create a license is received after the information is received.

17. A method implemented by one or more computers of compensating a consumer for providing information to a first company, the method comprising:
receiving a request to create a license, the license granting the first company the right to sublicense the information, the license obligating the first company to provide the consumer with a first percentage of the monies that the first company receives for sublicensing the information if the consumer updates the information within a certain time period and a second percentage of the monies that the first company receives for sublicensing the information if the consumer does not update the information within the certain time period;
receiving the information;
sublicensing the information to a second company; and
providing the consumer with either the first percentage or the second percentage of the monies received for sublicensing the information to the second company.

18. The method of claim 17, wherein receiving the request to create a license includes receiving a request to create a license that obligates the first company to obtain the consent of the consumer to sublicense the information to a second company.

19. The method of claim 17, wherein receiving the request to create a license includes receiving a request to create a license that obligates the first company to obtain the consent of the consumer to sublicense the information to a second company if the second company is in a first industry sector but not if the second company is in a second industry sector.

20. A method implemented by one or more computers of compensating a consumer for providing information to a first company, the method comprising:
receiving a request to create a license, the license granting the first company the right to sublicense the information, the license obligating the first company to provide the consumer with a first amount if the consumer updates the information within a certain time period and a second amount if the consumer does not update the information within the certain time period;
receiving the information;
sublicensing the information to a second company; and
providing the consumer with either the first amount or the second amount.

21. The method of claim 20, wherein receiving the request to create a license includes receiving a request to create a license that obligates the first company to obtain the consent of the consumer to sublicense the information to a second company.

22. The method of claim 20, wherein receiving the request to create a license includes receiving a request to create a license that obligates the first company to obtain the consent of the consumer to sublicense the information to a second company if the second company is in a first industry sector but not if the second company is in a second industry sector.
